(19) United States
(12) Patent Application Publication
(10) Pub. No.: US 2004/0071978 A1
(43) Pub. Date: Apr. 15, 2004

(54) Laminate and method of production

(75) Inventors: Lawrence E. Hallenbeck, Binghamton, NY (US); Michael Easterling, Reading, PA (US); Alfred Jenesky, Orwigsburg, PA (US)

Correspondence Address: JAGTIANI + GUTTAG, 10363-A DEMOCRACY LANE, FAIRFAX, VA, 22030, US

(73) Assignee: OMNOVA Solutions Inc.

(21) Appl. No.: 10/270,770

(22) Filed: Oct. 15, 2002

(51) Int. Cl. B32B 27/00; B32B 27/40

(52) U.S. Cl. 428/423.1; 428/423.7; 428/424.4; 522/4

(57) ABSTRACT

A laminate and the method for its formation are provided. The laminates comprise one or more polymeric layers and a surface coating layer which has been cured utilizing a specific sequence of ultra-violet (UV) irradiation, germicidal irradiation, and heat treatment. The laminates are produced by a process which imparts an aesthetically pleasing low-gloss finish to the crosslinked surface layer. Advantageously, the laminates can be used to realistically simulate patterns, wood, and wood grain finishes as they demonstrate enhanced depth of grain and print.

### FIELD OF INVENTION

The present invention relates to laminates, especially decorative laminates. The present invention particularly relates to laminates suitable for use as wall, ceiling, consumer electronics, or furniture coverings, moldings, or paneling, etc. with application to consumer electronics and wood-based substrates preferred. The laminates comprise one or more polymeric layers and a surface coating layer which has been cured utilizing a specific sequence of ultra-violet (UV) irradiation, germicidal irradiation, and heat treatment. The laminates are produced by a process which imparts an aesthetically pleasing low-gloss finish to the crosslinked surface layer along with desirable physical attributes. Advantageously, the laminates can be used to realistically simulate patterns, wood, and wood grain finishes as they demonstrate enhanced depth of grain and print.

### BACKGROUND OF THE INVENTION

Decorative laminates are widely used in the cabinet, molding, furniture, consumer electronics, paneling, and wall coverings industries. Conventional, decorative vinyl coverings are typically formed from a sheet of calendered poly(vinyl chloride) (PVC) resin printed on its front face with fanciful designs and colors. The marketplace is becoming increasingly more demanding for PVC having better physical attributes including low gloss, matted appearance, as well as stain and abrasion/scratch resistance.

Materials for wall, ceiling and furniture coverings should possess a wide variety of properties. An important property of materials for coverings is a good conformability to uneven or contoured surfaces to allow efficient application of the material to a base surface such as walls, furniture, molding, etc. The prior art materials are deficient in that they exhibit glossy, non-realistic, plastic looking finishes when applied to base surfaces.

### SUMMARY OF THE INVENTION

The present invention provides a decorative laminate suitable for use as wall, ceiling, consumer electronics, or furniture covering. A method for preparing the laminate is also disclosed. The laminates can be utilized to decorate structures, both permanent and consumable, in both commercial and residential settings including board rooms, conference rooms, hallways, meeting areas, and home interiors, etc.

The laminate generally-takes the form of an elongated sheet comprising a rigid or flexible material having essentially the same size and shape as conventional vinyl coverings. The laminate includes a plurality of layers permanently fixed to each other. The front face of the laminate preferably bears a decorative design. The laminate comprises a cured protective coating on the front face thereof to prevent the same from being damaged or destroyed.

The method of producing the laminate includes passing the covering through a series of curing or finishing steps comprising radiation curing and thermal drying. The laminates have desirable aesthetic properties such as low gloss, exceptionally smooth augmented appearance, and, for example, can beneficially provide more realistic wood grain appearance and enhanced physical properties such as abrasion/scratch, mar and stain resistance.

The substrate layer of the invention can generally be printed with any desired design or pattern using conventional printing techniques, and subsequently coated and cured to provide a unique aesthetic texture to form the laminate. The laminates of the invention can be applied to flat or rounded surfaces or bases using conventional adhesives, to provide a smooth, aesthetically pleasing, decorative covering.

### BRIEF DESCRIPTION OF THE DRAWINGS

The invention will be better understood and other features and advantages will become apparent by reading the detailed description of the invention, taken together with the drawings, wherein:

FIG. 1 is a perspective view of a laminate of the present invention.

FIG. 2 is a cross-sectional view of a laminate of the present invention.

FIG. 3 is a cross-sectional view of a laminate of the present invention adhered to a base.

### DETAILED DESCRIPTION OF INVENTION

The term “laminate,” “covering,” or the like as used herein refers to a multi-layered article, such as a sheet, flat board, etc., which is useful to cover at least a portion of a wall, ceiling, molding, paneling or the like, and which can be adhered to the same by means of a fastening agent, such as an adhesive system or the like.

The laminates of the present invention are preferably affixed to a wood or wood-derived base, forming a molding or furniture piece preferably having a wood, wood-grain, or patterned appearance thereon. Thus, faux wood laminates can be produced such as, but not limited to, wall molding, crown molding, paneling, and corner molding. FIG. 3 illustrates a laminate 10 of the present invention affixed to a wood base 20. A further preferred application is to affix the laminate to a consumer electronics housing formed from a wood or polymeric base.

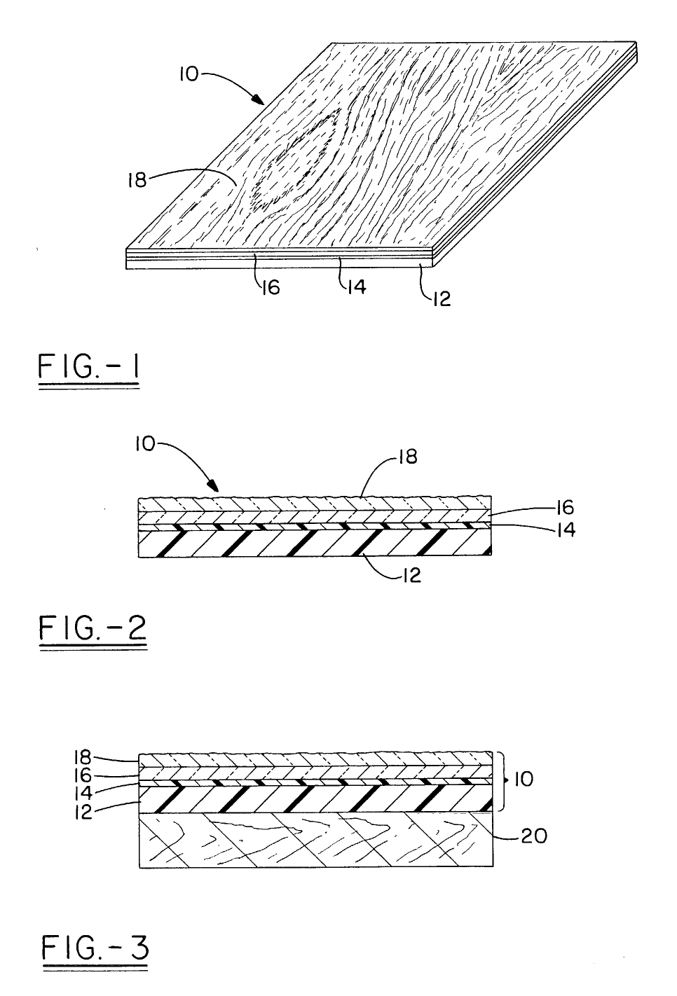

The inventive laminate 10 is multi-layered, as illustrated in FIG. 1, and can be used in the same way as conventional vinyl coverings. Therefore the laminate is made to have essentially the same size, shape and flexibility as conventional vinyl coverings which can vary greatly in size and shape depending on the end use application.

The inventive laminates can be made any conventional length and width, such as about 30 to about 60 inches (76.2 to about 152.4 cm) wide and about 50 to about 1,500 yards (45.72 to about 1,371.6 m) long.

The laminate 10 of the present invention includes a substrate layer 12. The substrate layer 12 can comprise one or more layers of (a) cellulosic material such as paper or sheeting derived from wood fibers, etc; or (b) a polymeric material, or (c) a combination thereof. Suitable combinations include, but are not limited to, multi-layered substrates and polymers having wood fibers therein. Polymeric materials are preferred. Examples of suitable polymeric materials include, but are not limited to, polyvinyl chloride (PVC), thermoplastic polyolefins (TPO) such as polyethylene and polypropylene, polyester, polyethylene terephthalate (PET), ethylene-styrene copolymers, polycarbonates, mineralized polyolefins, copolymers of each of the above polymers with at least one other monomer, or combinations thereof, with polyvinyl chloride being preferred. The substrate layer 12 is generally opaque and can include pigments, fillers, additives or the like as known in the art. Depending on the desired end use, the substrate layer can be chosen to be rigid or flexible. The substrate layer has a thickness which ranges, generally from about 3 to about 24 mils (about 0.0762 to about 0.6096 mm), desirably from about 4 to about 16 mils (0.1016 to about 0.4064 mm), and preferably from about 6 to about 10 mils (0.1524 to about 0.2540 mm).

The substrate layer 12 can be provided with a printed layer 14, illustrated in cross-section in FIG. 2, and visible through the overlay 16 and coating 18 in FIG. 1, on the surface to be viewed in order to provide an aesthetically pleasing design, pattern, or the like. Indicia can be provided by printing in a conventional manner as known in the art by methods such as, but not limited to offset, gravure, and digital printing. The printing or indicia can be a single color or more than one different color so that multi-colored designs are produced. The design can take essentially any form, and can be definite in its composition in the sense that it defines a picture or likeness of an object, letters, numbers, and outlines of information, wood grains, or the like. Alternatively, the design can be random in form such as a matted design. The design can also be a repeating pattern such as weaves or stripes. Formation and application of the printed layer to the substrate is well known in the art.

The printed layer can optionally have an overlay 16 thereon, as illustrated in FIG. 2, which is preferably clear or transparent. The overlay 16 is affixed to the substrate on top of the printed layer and comprises a polymer. Any of the above-noted polymers for the substrate layer can be utilized and are herein incorporated by reference. The overlay and the substrate layer are bonded together through the application of heat and pressure at suitable temperatures below the degradation temperatures of the polymers. Preferably, the overlay 16 and the substrate layer 12 comprise the same polymer, with polyvinyl chloride being preferred. The laminate comprising the overlay 16 and substrate layer 12 can be pressure rolled or embossed to impart a desirable design or imprint to form matting, ticks, or wormholes, etc., for example. The overlay has a thickness generally from about 2 to about 10 mils (0.051 to about 0.254 mm) and preferably from about 4 to about 6 mils (0.102 to about 0.152 mm).

The laminate of the present invention includes a stain and/or scratch resistant surface coating 18, as shown in FIG. 1, which has been cured by a process utilizing both ultra-violet wavelength irradiation and germicidal wavelength irradiation as well as thermal treatment. The surface coating 18 after curing imparts a satin smooth, low gloss, aesthetically pleasing appearance to the laminate. The low gloss appearance can be attributed to the curing process which produces “wrinkles” or relatively random ridges and valleys which can generally only be seen under optical magnification. Wrinkling can be controlled to be coarse or fine with varying physical and/or aesthetic attributes. The surface coating is applied over the printed layer or overlay, if any or both are present on the substrate. Although the surface coating utilized can be cured by ultra-violet irradiation or germicidal irradiation alone, both irradiation sources are utilized in the process of the present invention to produce the preferred laminate having desirable predetermined characteristics.

The surface coating of the present invention is a radiation crosslinkable polyurethane acrylate copolymer. The urethane component is formed from a polyether- and/or polyester-based diol reacted with an isocyanate, preferably a polyisocyanate which can be aromatic or aliphatic. Any of the known diisocyanates can be used and illustrative thereof one can mention 2,4-(or 2,6-)tolylene diisocyanate, 3-isocyanatomethyl-3,5,5-trimethylcyclohexyl isocyanate, diphenylmethane diisocyanate, 2,2,4-trimethylhexamethylene diisocyanate, xylylene diisocyanates, hexamethylene diisocyanate, dicyclohexyl-4,4′ methane diisocyanate, para,para′-4,4′-methylenebis-(phenyl isocyanate) (MDI), phenylene-1,4-diisocyanate (PPDI), 1,5-naphthalene diisocyanate (NDI), isophorone diisocyantate (IPDI), hexamethylene diisocyanate (HDI), 1,6-diisocyanato-2,2,4,4-tetramethyl hexane (TMDI), as well as any of the other known organic isocyanates. The urethane is crosslinked with a crosslinking agent which is preferably an acrylate component, which can comprise a number of different acrylates. Both the urethane component and the acrylate component are well known in the art.

The acrylates utilized can be mono-, di-, or polyacrylates with the polyfunctional acrylates being preferred. Examples of suitable acrylates include, but are not limited to, 2-ethylhexyl acrylate, hexamethylene diacrylate, glycidyl acrylate, ethylene glycol diacrylate, tripropylene glycol diacrylate, neopentyl glycol diacrylate, 2-methoxyethyl acrylate, and 2-phenoxyethyl acrylate. The surface coating composition has generally from about 0.1 to about 200 parts, and preferably from about 0.2 to about 100 parts of acrylate component per 100 parts by weight of the urethane component.

The surface coating composition can contain suitable or sufficient amounts of additives, initiators, fillers, etc. For example, N-vinyl pyrrolidone or other ketones can be utilized as an initiator, while silica, paraffin and hydrocarbon waxes can be utilized as fillers.

One suitable surface coating composition is commercially available from PPG of Pittsburgh, Pa. as Durethane® UV Low Gloss N. It is believed that Durethane UV Low Gloss N has the following composition: from about 50 to about 75 parts 2-ethylhexyl acrylate, from about 25 to about 50 parts amorphous silica, from about 25 to about 50 parts hexamethylene diacrylate, from about 2 to about 15 parts tripropylene glycol diacrylate, from about 2 to about 15 parts 2-phenoxyethyl acrylate, from about 2 to about 15 parts paraffin waxes and hydrocarbon waxes, and from about 10 to about 25 parts N-vinyl pyrrolidone (initiator), wherein the parts are based on 100 parts by weight of the urethane component.

The surface coating is applied to the laminate surface in an amount generally from about 8 to about 40 grams per square meter, desirably from about 12 to about 35 grams per square meter, and preferably from about 15 to about 30 grams per square meter (dry weight). Amounts lower than about 8 grams per square meter have been found insufficient to impart a uniform wrinkled effect to the laminate after curing, and generally result in the coating having a relatively glossy appearance.

In order to produce the laminate of the present invention having a low gloss, matte appearance, the following method is utilized to cure the surface coating. During curing, the coating “puckers” and contracts randomly to produce a “wrinkled” finish which, as stated hereinabove, generally cannot be seen without optical magnification, unless coarse wrinkles are intentionally produced. The surface of the coating has a continuous nature but is generally uneven, having random ridges, hills or crests; and/or furrows, troughs or valleys, and the like.

The disclosed coating and curing method for producing the laminates of the present invention comprises the steps of applying a urethane acrylate coating to a substrate, which can be printed and have an overlay thereon, partially curing the coating utilizing UV irradiation, heating the coated substrate through the application of heat, and curing the coating through the use of germicidal and UV irradiation. In order to provide the laminate with unique physical and aesthetic properties preferably a specific sequence of the above-noted radiation sources and thermal heating is utilized.

Laminate properties which can be achieved utilizing the method of the present invention include (a) low gloss of less than about 5.0 and preferably between about 1.0 or 3.0 to about 5.0 measured at a 60 degree angle using a Gardner gloss meter, (b) a flat, matted appearance, (c) creation of visual depth when applied to printed patterns, especially wood grains, (d) high resistance to scratching, marring, and staining when measured by specific universal test procedures and standards such as KCMA and NEMA, (e) a wide variety of textures to create degrees of smoothness, and (f) a more realistic appearance when applied to wood grained laminates. Textures are dependent upon the degree of wrinkling and the size of the wrinkles.

The process of curing a coating on a decorative substrate to form the laminate of the present invention comprises at least one heating/drying step, and at least two radiation curing steps independently utilizing ultra-violet radiation exposure and germicidal radiation exposure.

The radiation curing of the surface coating is preferably conducted in an oven or other substantially closed or controlled system under an inert atmosphere, such as nitrogen, argon, helium, or neon, preferably nitrogen. The controlled system includes a number of different individual stations or lamp banks for the different steps of the process. Both the germicidal radiation exposure and ultra-violet radiation exposure steps are conducted in the controlled system at a temperature generally from about 65° F. (18° C.) to about 90° F. (32° C.), desirably from about 70° F. (21° C.) to about 86° F. (30° C.), and preferably room temperature.

The first step of the surface coating curing process includes an ultra-violet light radiation exposure precure step wherein the coated laminate is exposed to ultraviolet radiation having a wavelength spectrum generally from above about 240 to about 450 nm, desirably from about 250 to about 420 nm, and preferably from about 255 to about 410 nm for a period of time. The intensity of the UV radiation is generally from about 50 to about 600 watts/linear inch (about 19.7 to about 236 w/linear cm), desirably from about 100 to about 300 watts/linear in (about 39.4 to about 118 w/linear cm) and preferably about 260 watts/linear in (about 102.4 w/linear cm). It has been found that the ultra-violet curing step initiates a bulk cure of the coating.

In the coating curing process, the coated laminate is exposed to an elevated temperature in a heating step. The applied heat from a heat source ranges generally from about 100° F. (37.7° C.) to about 10° F. (6° C.) below the melt point of the substrate, i.e., about 220° F. (104.4° C.) for polyvinyl chloride, desirably from about 130° F. (54.4° C.) to about 160° F. (71.1° C.), and most preferably from about 135° F. (57.2° C.) to about 145° F. (62.8° C.), for a suitable period of time, which is dependent upon the substrate web speed. It has been found that the applied heat aids in dulling or matting the appearance of the coating and in formation of the flat or matte finish.

The surface coating is also cured with a germicidal lamp wherein the coated laminate is exposed to germicidal light radiation having a wavelength spectrum generally from about 100 to about 240 nm, desirably from about 150 or 160 to about 220 nm, and preferably from about 170 to about 200 nm, for a suitable period of time. The intensity of the germicidal light is preferably from about 0.39 watts/linear cm to about 7.87 watts/linear cm, more preferably from about 0.39 watts/linear cm to about 5.91 watts/linear cm and most preferably from about 0.39 watts/linear cm to about 3.93 watts/linear cm. It has been found by the inventor that the lower intensity and wavelength of the germicidal lamp has minimal penetrating power when compared with the UV lamp and thus tends to effect a cure from the top of the coating layer.

A preferred surface coating curing process sequence is set forth hereinbelow. After any of the above-stated pre-surface coating steps are completed, the surface coating is applied to the laminate by any suitable method such as spraying, brushing, rod, cascade, curtain coating, and preferably rotogravure. The coated laminate is then conveyed through the controlled system at a line speed sufficient to cure the coating and produce a laminate having the necessary degree of “wrinkling” to provide the desired physical and aesthetic surface characteristics.

In the preferred process, the laminate comprising the uncured surface coating thereon is exposed to ultra-violet radiation for a predetermined period of time and then heated to an elevated temperature in a separate heating step. As stated above, this exposure step will begin to cure the bulk of the coating. Afterwards, the coated laminate is exposed to germicidal radiation for a predetermined time period, which effects a cure at the top, upper portion of surface coating. Following the germicidal exposure step, the laminate is reexposed to or subjected to a second round of ultra-violet radiation to further cure the coating. The first and second ultra-violet radiation curing steps can have the same or different intensities and/or wavelengths.

In a preferred embodiment the thermal heating step time compared to the first ultra-violet irradiation step time ranges generally from about 1:1 to about 15:1, and preferably from about 5:1 to about 8:1. The germicidal radiation curing step time ranges from about 0.5:1 to about 2:1, and preferably from about 0.8:1 to about 1.2:1, when compared to the length of time period of the initial ultra-violet radiation precure exposure step. Likewise, the second ultra-violet radiation exposure step when compared-to time length the ultra-violet radiation precure exposure step ranges from about 1:1 to about 10:1, and preferably from about 3:1 to about 5:1.

For example, at a line speed of 30 yards/minute (27.43 mimin), typical residence times for each section can be: (a) a first ultra-violet radiation curing exposure in a 5 foot (1.52 m) section for 3 seconds, (b) applied heat at 140° F. (60° C.) in two sections for 19 seconds total, (c) a germicidal radiation curing exposure in a 6 foot (3.04 m) section for 4 seconds, and (d) a second ultra-violet radiation curing exposure in a 16 foot (4.88 m) section for 11 seconds. This preferred process order has been found to produce laminates comprising cured coatings having desirable characteristics.

The control over the extent of microscopic wrinkling in order to produce a matte or low gloss surface on the laminate can be accomplished by (a) varying the coat weight of the topcoat (a thicker coating layers will allow more wrinkling), (b) increasing the amount of inerting present during the germicidal radiation lamp exposure, (c) adjusting the web speed to allow more or less residence time under the germicidal and UV radiation lamps, and (d) manipulating the number and sequence of germicidal radiation lamps being used.

The laminates of the present invention are particularly preferred, but not limited to, for use as coverings for wall paneling, molding, furniture and consumer electronics. Laminates of the present invention having a wood grain substrate or printed layer demonstrate enhanced depth of grain and more realistic natural wood-like appearance than conventional vinyl coated products which possess a more “plastic” look. Depending on the types and amounts of components and optional additives utilized, the coverings of the present invention exhibit properties, including but not limited to, such as abrasion/scratch, mar, stain or indentation resistance, indentation recovery, good flexibility and conformability over flat, contoured, or uneven surfaces, as well as aesthetic properties including a matte, low gloss finish.

Generally, common adhesives can be used to affix the coverings on a base layer. Suitable base layers include wood based substrates such as MDC board, glued wood fibers, natural wood, or the like. The use of adhesion promoters, such as surface oxidation via corona, or flame treatment, or acrylic primers in combination with these adhesives is generally not necessary, but are not excluded.

The following examples are provided to illustrate the present invention. The examples are not intended to limit the scope of the present invention and should not be so interpreted.

### LAMINATE EXAMPLES

Eight different laminates were prepared utilizing the method of the present invention. The process utilized to prepare the laminates was identical except that each laminate had a different printed pattern, grain, and/or color. A poly(vinyl chloride) substrate was utilized OTPL, H4, E-727 embossing before coating. The thickness of the poly(vinyl chloride) substrate was 6 mils (0.1524 mm). The substrate was printed with the respective printing layer as indicated in Table 1, laminated with a clear poly(vinyl chloride) overlayer and embossed. Afterwards, the laminate had a Durethane UV Low Gloss N urethane acrylate coating available from PPG of Pittsburgh, Pa. applied thereto in an amount to produce a dry weight of 16 grams per square meter. The coated substrate was sent through an oven at room temperature under a nitrogen atmosphere wherein a three-part radiation curing process was applied thereto. In a first step of the curing process, the laminate was exposed to ultra violet radiation having a wavelength of 345 nm and an intensity of 102 watts/linear cm. Then the coated laminate was heated to 60° C. in a separate heating zone wherein no inerting was applied. In a further cure step, the laminate was exposed to germicidal radiation having a wavelength of 180 nm and an intensity of 1.97 watts/linear cm. In a final curing step, the laminate was exposed again to UV radiation having a wavelength of about 345 nm and an intensity of about 102 watts/linear cm. At a web speed of 30 yards/minute, each portion of the substrate was exposed to first UV radiation 13.8 seconds per yard, heated to a temperature of 60° C. for 19 seconds per yard, germicidal radiation for 3.9 seconds per yard, and the second UV radiation for 13.8 seconds per yard.

Each laminate was tested for various physical properties including gloss and Hoffman Scratch. The laminates prepared by the method of the present invention advantageously had gloss values of less than or equal to 3.2 when measured by a Gardner gloss meter at a 60° angle. The physical results of the sample laminates are listed below in Table 1.

TABLE I

| | | | | | | | | | Flexibility | | |
|---|---|---|---|---|---|---|---|---|---|---|---|
| | | | | Taber | | Surface Tension | | | Film Crack | Crease | UV |
| Laminate Name | Gloss | Hoffman | Burnish | (cycles) | Adhesion | Front | Back | Blocking | crack | Whiting | Coating |
| Ebony | 1.9 | 2000 | 9 | 1566 | 100% | 34 | 34 | 0 | NO | | |
| Tempest Oak | 1.4 | 2000 | 9 | 1580 | 100% | 34 | 32 | 0 | NO | NO | NO |
| Anglewood | 2.9 | 2000 | 9 | 1197 | 100% | 34 | 34 | 0 | NO | NO | NO |
| Malachite | 1.3 | 2000 | 9 | 941 | 100% | 36 | 34 | 0 | NO | NO | NO |
| Weathered Copper | 3.2 | 1800 | 9 | 1316 | 100% | 34 | 34 | 0 | NO | NO | NO |
| Candlelight Pine | 2 | 2000 | 9 | 1147 | 100% | 34 | 30 | 0 | NO | NO | NO |
| Blue Onyx | 1.3 | 2000 | 9 | 1042 | 100% | 36 | 34 | 0 | NO | NO | NO |
| Wisconsin Maple | 3 | 2000 | 9 | 812 | 100% | 36 | 34 | 0 | NO | NO | NO |
| Test Designation | | LAB 030 | LAB | NEMA LD | LAB 027 | LAB | LAB | LAB 028 | LAB 029 | LAB 029 | LAB 029 |
| | | | 026 | 3-1995 | | 028 | 028 | | | | |

The above-noted procedures were carried out on 4″×4″ (10.2 cm×10.2 cm) samples, unless otherwise indicated as follows:

Hoffman Scratch

A Hoffman Scratch meter was placed on the sample with a 2,000 g setting and enough downward pressure was applied on the unit to maintain a horizontal weighted arm position throughout the scratch. If scratch was evident, the weight was reduced until no material was scratched off.

Burnish

The sample was rubbed with a weighted test tool in a circular manner. If point of contact turned shiny, the same was lightly rubbed with an alcohol soaked cloth to see if the shine disappeared after the alcohol dried. A rating of 10 is best (no mark), 9 moderate (marks but is removed with alcohol), and 8 severe (marks but cannot be removed with alcohol).

Taber Test

NEMA Test LD 3-1995 Taber Test procedure was utilized on an Abraser Model 503 standard abrasion tester.

Adhesion

A 5 bladed scratch tool was used to make a three-pass, star shaped cross hatch. A piece of #600 tape was applied across the center of the scratched area and smoothed down. The tape was abruptly pulled off to see if the coating came off. If any coating was removed at all, the sample failed.

Surface Tension

A #32 dyne pen was used to make three parallel lines, about 2″ long, on the sample. After waiting 3 seconds, the sample was observed to see if the lines maintained their integrity and did not repel or pull as if it was drying up, or unwetting. If the line did so, the next higher pen, a #34 was used. This is continued until failure. After failure, the sample was tested with a passing pen # equal to one lower pen #. If it failed, the next lower pen, was used to repeat the procedure until a passing pen was found.

Blocking

Two 6″ (15.24 cm) squares of material were cut and placed face to face between the two test pads. The sample was placed in the press at 115° F. (46.1° C.) under 1 ton of pressure for ten minutes. The sample was removed and allowed to cool to room temperature. The sample is then cut into five 1″ (2.54 cm) strips on the cutting board and a hole was punched into one end to pass through one layer, and the second layer pulled until the halves separated. The final rating was the average of the grams of pull required to pull the strips apart for all five pieces. >50 g represents failure. The same test was repeated for 6″ (15.24 cm) squares placed face to back.

Flexibility

A 4″×4″ (5.08 cm×5.08 cm) square was cut from the sample and placed in a 40° F. (4.4° C.) refrigerator for 10 minutes. The sample was removed and severely creased in the center, backside facing inwardly. Crease whiting (CW), film crack (FC), and UV coating crack (UVCC) were evaluated. The samples are rated as no effect, moderate, or severe.

### Example 2

### Stain Resistance

The Ebony laminate from the above example was also tested for stain resistant properties according to NEMA's stain resistance test LD 3.4 1995. Results are indicated in Table II below. As can be seen, the Ebony laminate did not stain in the presence of substantially all of the test reagents. The score obtained by the Ebony laminate was well below the highest passing score of 25 designated by the NEMA standards.

TABLE II

| Test Reagent | | | |
|---|---|---|---|
| # | Stain | Score | Stain |
| 1 | Distilled Water | 0 | N |
| 2 | Ethanol/Water, 50/50 | 0 | N |
| 3 | Acetone | 0 | N |
| 4 | Household Ammonia | 0 | N |
| 5 | 10% citric acid | 0 | N |
| 6 | Vegetable Cooking Oil | 1 | N |
| 7 | Coffee | 0 | N |
| 8 | Tea | 0 | N |
| 9 | Tomato Catsup | 0 | N |
| 10 | French's Mustard | 5 | Moderate |
| 11 | 10% Iodine | 3 | N |
| 12 | Supermarket Stamp | 0 | N |
| | Ink | | |
| 13 | #2 Pencil | 1 | N |
| 14 | Wax Crayon | 3 | N |
| 15 | Black Shoe Polish | 5 | Severe |
| | | Total = 18 | |
| | | Passing | |
| | | is < 25 | |

Stain Legend
N = No Effect
M = Moderate Effect; difficult to perceive stain
S = Severe Effect; easily perceived stain
NEMA stain resistance test LD 3.4 1995

In accordance with the patent statutes, the best mode and preferred embodiment have been set forth, the scope of the invention is not limited thereto, but rather by the scope of the attached claims.

What is claimed is:

1. A method for producing a laminate comprising the steps of:
exposing a laminate comprising a substrate and a radiation curable surface coating to:
a) a first source of UV radiation having a wavelength of from above about 240 to about 450 nm and an intensity from about 19.7 to about 236 watts/linear cm;
b) germicidal radiation having a wavelength of from about 100 to about 240 nm and an intensity from about 0.39 watts/linear cm to about 7.87 watts/linear cm; and
c) a second source of UV radiation having a wavelength of from about 240 to about 450 nm and an intensity from about 19.7 to about 236 watts/linear cm; said coating being cured through said radiation exposure steps.

2. A method according to claim 1, further comprising the step of heating said coated laminate after said radiation exposure to said first source of UV radiation to a temperature of from about 37.7° C. to about 6° C. below a melting point of the substrate, and wherein said radiation exposure steps are conducted in an inert atmosphere.

3. A method according to claim 2, wherein said substrate is a cellulosic material or a polymeric material, and wherein said substrate has a thickness of about 0.0762 to about 0.6096 mm.

4. A method according to claim 3, wherein said radiation curable surface coating is a urethane acrylate composition, and wherein said radiation curable surface coating is present on said laminate in an amount from about 10 to about 40 grams per square meter (dry weight).

5. A method according to claim 4, wherein said first source of UV radiation has a wavelength of from about 250 to about 420 nm and an intensity of from about 39.4 to about 118 watts/linear cm, wherein said germicidal radiation has a wavelength of from about 150 to about 220 nm and an intensity of from about 0.39 watts/linear cm to about 5.91 watts/linear cm, and wherein said second source of UV radiation has a wavelength of from about 250 to about 420 nm and an intensity of from about 39.4 to about 118 watts/linear cm.

6. A method according to claim 1, wherein said substrate is printed with indicia before said radiation curable surface coating is applied to said substrate.

7. A method according to claim 6, wherein said printed substrate includes a substantially transparent overlay on said printing which is applied before said coating.

8. A method according to claim 3, wherein said substrate is a polymeric material comprising poly(vinyl chloride), a thermoplastic polyolefin, polyester, polyethylene terephthalate (PET), ethylene styrene copolymer, polycarbonate, or combinations thereof.

9. A method according to claim 8, wherein said polymeric material is poly(vinyl chloride).

10. A method according to claim 2, wherein said germicidal radiation curing step is conducted for a time which ranges from about 0.5:1 to about 2:1 when compared to the time of said first source of UV radiation exposure, and wherein said second ultra-violet radiation exposure step is conducted for a time which ranges from about 1:1 to about 10:1 when compared to the time of said first source of UV radiation exposure, and wherein said heating step is conducted for a time which ranges from about 1:1 to about 15:1 when compared to the time of said first source of UV radiation exposure.

11. A method according to claim 2, wherein said laminate has a gloss of less than about 5.0 measured at a 60° angle by a Gardner gloss meter.

12. A laminate produced by the method according to claim 1.

13. A laminate produced by the method according to claim 3.

14. A laminate produced by the method according to claim 5.

15. A laminate produced by the method according to claim 6.

16. A laminate produced by the method according to claim 8.

17. A laminate produced by the method according to claim 10.

18. A laminate, comprising:
a substrate layer;
printing on at least a portion of said substrate layer; and
a cured coating on said printing, said coating having a gloss of less than about 5.0 measured at a 60° angle using a Gardner gloss meter, said coating having a wrinkled surface.

19. A laminate according to claim 13, wherein said cured coating is a urethane acrylate composition.

20. A laminate according to claim 14, wherein said cured coating has a gloss of from about 1.0 to about 5.0 measured at a 60° angle using a Gardner gloss meter.

21. A laminate according to claim 20, wherein said laminate includes an overlay between said printing and said coating.

22. A laminate according to claim 19, wherein said substrate layer comprises a cellulosic material or a polymeric material, and wherein said substrate has a thickness of about 0.0762 to about 0.6096 mm.

23. A laminate according to claim 22, wherein said substrate is a polymeric material comprising poly(vinyl chloride), a thermoplastic polyolefin, polyester, polyethylene terephthalate (PET), ethylene styrene copolymer, polycarbonate, or combinations thereof.
